(19) United States
(12) Patent Application Publication
(10) Pub. No.: US 2011/0154095 A1
(43) Pub. Date: Jun. 23, 2011

(54) Management of Space in Shared Libraries

(75) Inventors: Vandana Maalempati, Austin, TX (US); Srinivasa Raghavan, Round Rock, TX (US); Prakash Ranganathan, Austin, TX (US); Aruna Yedavilli, Austin, TX (US)

(73) Assignee: International Business Machines Corporation, Armonk, NY (US)

(21) Appl. No.: 12/643,819

(22) Filed: Dec. 21, 2009

(51) Int. Cl. G06F 11/07

(52) U.S. Cl. 714/2; 714/E11.023; 714/37

(57) ABSTRACT

Any computer process has the opportunity of attempting to load a data object into a global shared library area and, in the event that there is insufficient space in this global area resulting in a failure to load, there is then an automatic location or creation of a named shared library area for the data object that is transparent and does not need and user action.

### TECHNICAL FIELD

The present invention is directed to shared libraries, and particularly to the management and distribution of library space shared between data from a plurality of data processes being loaded into the shared library.

### BACKGROUND OF RELATED ART

Shared libraries in which a plurality of different computer processes are running on a computer input, i.e. load data objects for storage in shared library space, are prevalent and essential to information processing systems. In such shared libraries, it is important that the loading of data objects from processes and applications running on computers and being loaded into the shared libraries be achieved smoothly and seamlessly with respect to the computer users.

Definition of process data objects: throughout this description and claims, the term “process data objects” will be used. This term, as used herein, is intended to cover any data element that a process running on the computer loads into the shared library. This would include the data to be stored, together with any instructions (text) or any other supporting information.

In AIX systems, there are provided shared libraries for 32-bit processes in which the shared library provides a global set of segments referred to as the global shared library area. This global area consists of one segment for shared library text (segment OxD), i.e. execution instructions, and one segment for the pre-relocated library data (segment OxF), i.e. the data from the specific computer process. This sharing of library text and pre-relocating of the computer process data has improved smooth and seamless performance with respect to the users of the computers providing the data to the snared libraries. However, because the global shared library area is a single resource of a fixed size, situations arise where attempts to share a set of libraries by data from a computer process that exceed the capacity of the global shared library area resulting in a failure to load. In such situations, a portion of these data libraries from the providing computers end up being loaded privately in association with the providing computers. Of course, such private loading consumes private address space in the computer process that may diminish and limit overall computer system performance.

To remedy this limitation of the global shared library area, AIX systems have now provided named shared library areas. For specific information on such named shared library areas, reference is made to: IBM System p and AIX 5L Information Center, AIX Documentation, Shared Libraries and Shared Memory, Named Shared Library Area (http://publib.boulder.ibm.com/infocenter/p series/v5r3/Index).

This named shared library area has been made available as an alternative to the global shared library areas for users who wish to avoid the above-described possible inconveniences. With the named shared library area loading, the user's computer process that is inputting the data object that may be in the form of a library, must specify a particular named shared library area by a unique name. The shared library area is chosen by the computer process inputting the data, which then causes the creation of the named shared library. In AIX, the named shared library feature is enabled by the LDR_CNRL environmental variable. With this approach, it is necessary for the user's computer to process and make a decision as to whether the data object being loaded into the shared library is to be put in the global shared library area or whether a named shared library area is to be located or created for the process data object. In other words, where a data object from a computer process is attempted to be loaded into a global shared library area and there is insufficient space, the above-described capacity problems will arise and the user may have to intervene and begin to create the named shared library area.

### SUMMARY OF THE INVENTION

The present invention improves upon the prior art situation in that it provides any computer process with the opportunity of attempting to load a data object into the global shared library area and, in the event that there is insufficient space in this global area resulting in a failure to load, then there is an automatic location or creation of a named shared library area for the data that is transparent and does not need and user action.

In its broadest aspects, the present invention provides a method and computer program for providing sufficient shared space in shared libraries for storing computer process data comprising attempting to load a specific computer process data object into a global shared library area and responsive to a failure to load the specific process data object due to insufficient capacity in the global shared library area, automatically creating and naming a new named shared library area for the specific process data object, without any user interaction.

More specifically, the invention provides a method, wherein there is a continuous attempting to load a plurality of computer process data objects into shared library areas, comprising loading computer process data objects for which there is sufficient capacity into global shared library areas, monitoring the loading of the computer process data objects to detect said failures to load and automatically creating and naming new named shared library areas for specific process data objects in response to detected failures to load.

The library capacity required for the specific process data objects is calculated based upon library text and library data space for the specific process data objects.

The monitoring of the loading and the automatic creation of the new named shared library areas is carried out by a load inspector daemon (AIX system) continuously monitoring the computer process data objects being loaded into said global shared library areas. The present invention may effectively be implemented with computer process objects being loaded from 32-bit processes for AIX computer operating systems.

The named shared library areas are coextensive and coactive with said global shared library area in said shared libraries. Also, in the automatic creation of new shared library areas, locating an existing named shared library area having the capacity to store the specific process objects may be used.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system to illustrate the shared library arrangement to which the present invention applies;

FIG. 2 (2A-2B) is a generalized block diagram showing prior art loading of data from computer processes into shared library areas;

FIG. 3 is a generalized block diagram showing how the present invention handles data object distribution between global shared library areas and named shared library areas in the event of a failure to load in global shared areas;

FIG. 4 is a general flowchart of a program set up to implement the present invention for loading a data object into the global shared library area and, in the event that there is insufficient space in this global area resulting in a failure to load, automatically creating a named shared library area for the data; and

FIG. 5 is a flowchart of an illustrative run of the program set up in FIG. 4.

### DETAILED DESCRIPTION OF THE PREFERRED EMBODIMENT

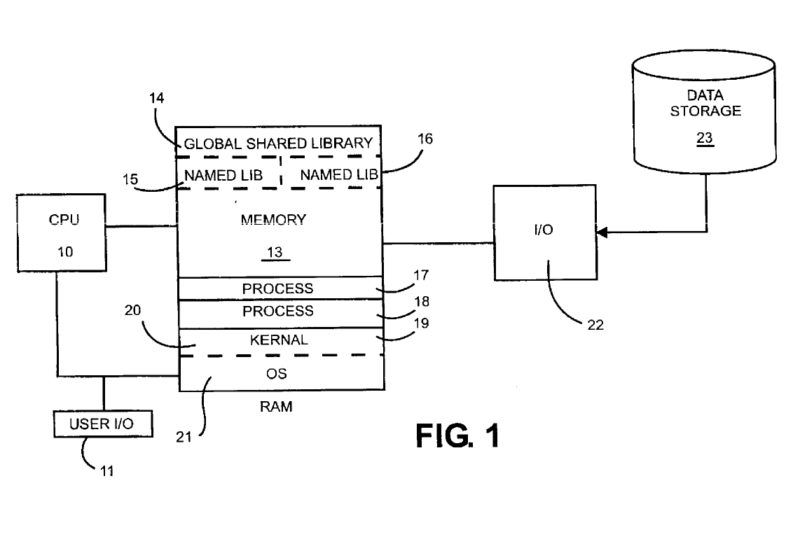

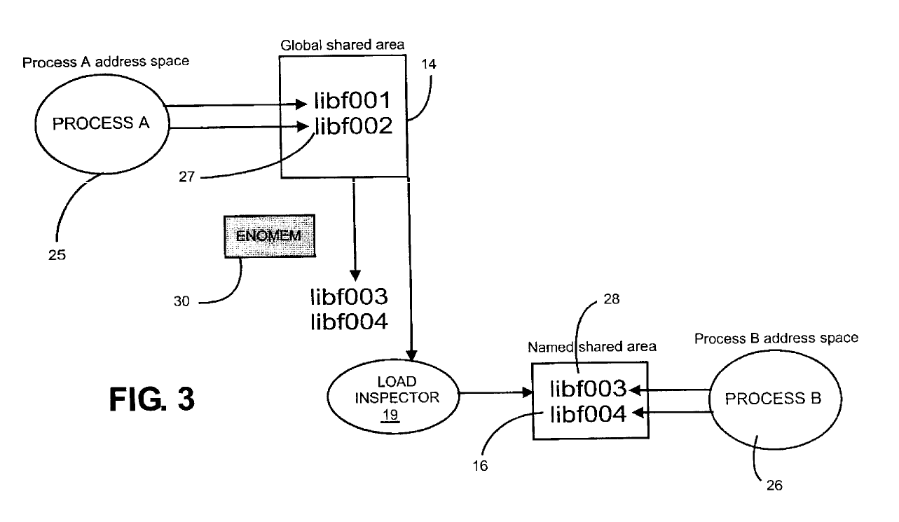

Referring to FIG. 1, there is shown a generalized diagrammatic view of shared library system supporting a data processing system to illustrate the shared library arrangement to which the present invention applies. User I/O 11, when required, is applied under the control of CPU 10. For simplicity of illustration, the basic RAM 13 includes the shared library that is made up of a global shared area 14 and named shared areas 15 and 16. Processes 17 and 18 are being run on the computer system and are providing the process data objects that are to be loaded into the global shared library 14 and/or the named shared areas 15 and 16, as will hereinafter be described with respect to FIGS. 3 through 5. It should be noted that the process data objects have been defined hereinabove as any data element that a process running on the computer loads into the shared library. This would include the data to be stored together with any instructions (text) or any other supporting information. The load inspector daemon 19, to be subsequently described, is in kernel 20 of operating system 21. Conventional ancillary storage, e.g. disk drive 23, is connected via I/O 22.

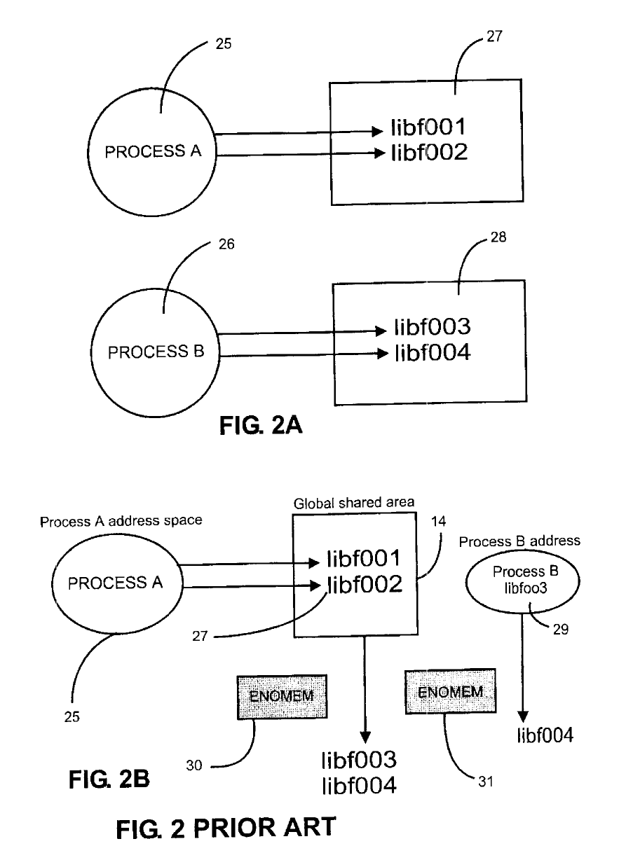

The operation of the library system shown will be described in terms of prior art with respect to FIG. 2 and, with respect to the present invention, with respect to FIGS. 3 through 5.

In FIG. 2A, Process A 25, running on a computer needs to load two of its data libraries 27: libfoo1 and libfoo2 (as a data object) into the global shared library area 14, FIG. 1; and Process B 26, running on a computer needs to load two of its libraries 28: libfoo3 and libfoo4 (as a data object) into the global library area 14, FIG. 1. As it turns cut, there is sufficient capacity in the global shared library area 14 for the data object from Process A 25. Thus, FIG. 2B, libfoo1 and libfoo2 are loaded into the global library area 14 but there is not enough room for loading libfoo3 and libfoo4, as indicated by environmental variable ENOMEM 30. With respect to Process B data, it appears that since the global shared library area has no room, Process B has succeeded in loading libfoo3 in its own private address space 29 that has become full, so that libfoo4 cannot even be privately stored. This results in an ENOMEM output 31 indicating a failure to load libfoo4. In such prior circumstances, in AIX, 32-bit processes, the user would then have to get involved, create a named shared library area for libfoo4, of Process B through a LDR CNTRL environmental variable.

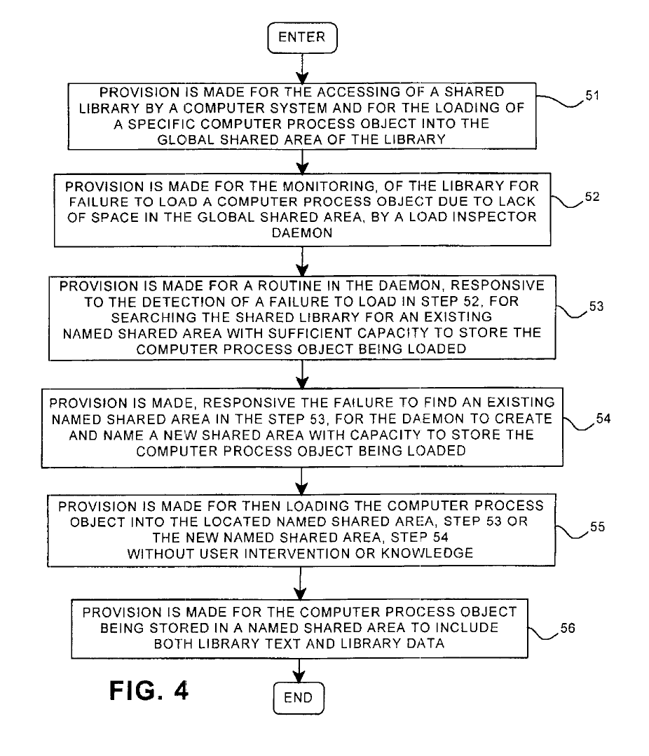

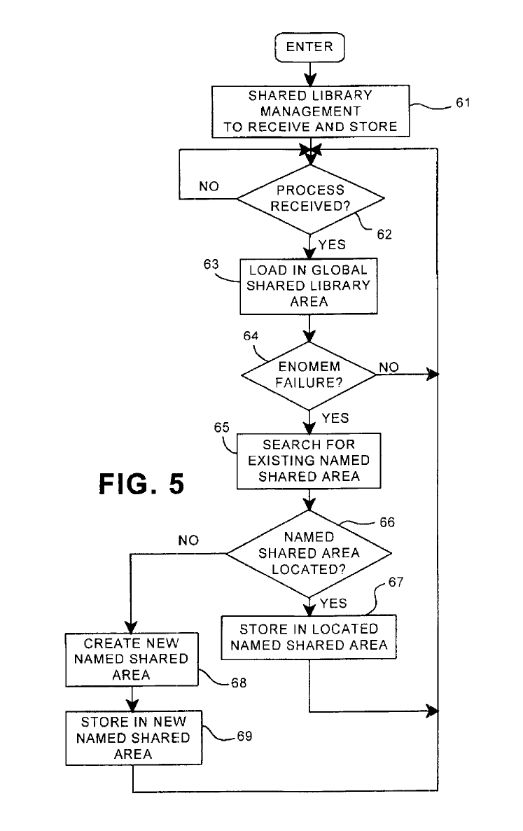

However, with respect to FIG. 3, the present invention will be diagrammatically illustrated using the elements of FIGS. 2A and 2B, where indicated. As will hereinafter be described in greater detail with respect to FIGS. 4 and 5, load inspector 19 is an AIX daemon that monitors the ENOMEM outputs 30. Thus, with respect to libfoo1 and libfoo2 (27) from process A 25, the monitoring indicates that these data libraries have been successfully loaded into the global shared library area 14 and no further action need be taken. However, with respect to libfoo3 and libfoo4 (28) from Process B 26, the load inspector routine 19 functions within kernel 20, FIG. 1, has without any action by the user of Process B, created a named shared library area 16, FIG. 3, wherein libfoo3 and libfoo4 are loaded.

FIG. 4 is a flowchart showing the development of a process according to the present invention for providing any computer process with the opportunity of attempting to load a data object into the global shared library area and, in the event that there is insufficient space in this global area resulting in a failure to load, there is then an automatic location or creation of a named shared library area for the data without user action. Provision is made for the accessing of a shared library by a computer system and for the loading of a specific computer process data object into the global shared library area, step 51. Provision is made for the monitoring by a load inspector daemon for the library for failure to load a computer process data object due to a lack of space in the global shared library area, step 52. Provision is made for a routine in the daemon, responsive to the detection of a failure to load in step 52, for searching the shared library for an existing named shared library area with sufficient capacity to store the computer process object being loaded, step 53. Provision is made, responsive to the failure to find an existing named shared area in step 53, for the daemon to create and name a new named shared library area with the capacity to store the computer process data object being loaded, step 54. Provision is made for then loading the computer process data object into the located named shared library area of step 53 or the new named shared library area without user intervention or knowledge, step 55. Prevision is made for the computer process object being scored in a named shared area to include both library text and library data, step 56.

A flowchart of an illustrative run of the program set up in FIG. 4 for providing any computer process with the opportunity of attempting to load a data object into the global shared library area and, in the event that there is insufficient space in this global shared library area resulting in a failure to load, there is an automatic location or creation of a named shared library area for the data without user action will now be described with respect to FIG. 5. In a shared library, provision is made for the receiving and loading of data objects from computer processes, step 61. A determination is first made as to whether data from a computer process has been received at the shared library, step 62. If No, such data objects are awaited. If Yes, the attempt is made to store, i.e. to load the data into the global shared library area, step 63, after which a determination is made, step 64, as to whether there has been a failure to load. If Yes, there has been a failure to load as represented by an ENOMEM output, there is a search of the shared library for an existing named shared library area with sufficient space for the data object being loaded, step 65. A determination is made as to whether such a named shared area has been located, step 66. If Yes, the data object is loaded into the located named shared area, step 67. If No, a new named shared library area is created, step 68, and the data object is loaded into the located named shared area, step 69. After steps 67 and 69, as well as a No decision from step 64, process flow is returned to step 62, wherein a determination is made as to whether the next data object from a computer process has been received at the shared library.

Although certain preferred embodiments have been shown and described, it will be understood that many changes and modifications may be made therein without departing from the scope and intent of the appended claims.

What is claimed is:

1. A method for providing sufficient shared space in shared libraries for storing computer process data comprising:
attempting to load a specific computer process data object into a global shared library area; and
responsive to a failure to load said specific process object due to insufficient capacity in said global shared library area, automatically creating and naming a new named shared library area for said specific process object, without any user interaction.

2. The method of claim 1, wherein:
there is a continuous attempting to load a plurality of computer process data objects into global shared library areas; and further including:
loading computer process data objects for which there is sufficient capacity into global shared library areas;
monitoring the loading of said computer process data objects to detect said failures to load; and
automatically creating and naming said new named shared library areas for said specific process data objects in response to detected failures to load.

3. The method of claim 2, wherein said library capacity required for the specific process data objects is calculated based upon library text and library data space for the specific process data objects.

4. The method of claim 2, wherein said monitoring of the loading and automatically creating said new named shared library areas is carried out by a load inspector daemon continuously monitoring the computer process data objects being loaded into said global shared library areas.

5. The method of claim 4, wherein said computer process data objects being loaded are 32-bit processes for AIX computer operating systems.

6. The method of claim 4 wherein said named shared library areas are coactive with said global shared library area in said shared libraries.

7. The method of claim 4 wherein automatic creating of new shared library areas includes locating an existing named snared library area having the capacity to store the specific process data objects.

8. A system for providing sufficient shared space in shared libraries for storing computer process data, the system comprising:
a processor;
a computer memory holding computer program instructions that, when executed by the processor perform the method comprising:
attempting to load a specific computer process data object into a global shared library area; and
responsive to a failure to load said specific process data object due to insufficient capacity in said global shared library area, automatically creating and naming a new named shared library area for said specific process data object without any user interaction.

9. The system of claim 8, wherein:
there is a continuous attempting to load a plurality of computer process data objects into global shared library areas; and
said performed method further includes:
loading computer process data objects for which there is sufficient capacity into global shared areas;
monitoring the loading of said computer process data objects to detect said failures to load; and
automatically creating and naming said new named shared library area for said specific process data objects in response to detected failures to load.

10. The system of claim 9, wherein said performed method calculates the library capacity required for the specific process data object based upon library text and library data space for the specific process data object.

11. The system of claim 9, wherein said monitoring the loading and automatically creating said new named shared library areas in the performed method is carried out by a load inspector daemon continuously monitoring the computer process objects data being loaded into said global shared library areas.

12. The system of claim 11, wherein said computer process data objects being loaded are 32-bit processes for AIX computer operating systems.

13. The system of claim 11 wherein said named shared library areas are coactive with said global shared library area in said shared libraries.

14. A computer usable storage medium having stored thereon a computer readable program for providing sufficient shared space in shared libraries for storing computer process data, wherein the computer readable program, when executed on a computer, causes the computer to:
attempt to load a specific computer process data object into a global shared library area; and
responsive to a failure to load said specific process data object due to insufficient capacity in said global shared library area, automatically create and name a new named shared library area for said specific process data object without any user interaction.

15. The computer usable storage medium of claim 14 wherein there is a continuous attempting to load a plurality of computer process data objects into global shared library areas; and
the computer program, when executed, further causes the computer to:
load computer process data objects for which there is sufficient capacity into global shared library areas;
monitor the loading of said computer process objects to detect said failures to load; and
automatically create and name said new named shared library areas for said specific process objects in response to said detected failures to load.

16. The computer usable storage medium of claim 15, wherein said library capacity required for the specific process objects is calculated based upon library text and library data space for the specific process objects.

17. The computer usable storage medium of claim 15, wherein said monitoring of the loading and automatically creating said new named shared library areas is carried out by a load inspector daemon routine that, when executed on a computer, causes the computer to continuously monitor the computer process data objects being loaded into said global shared library areas.

18. The computer usable storage medium of claim 17, wherein said computer process data objects being loaded are 32-bit processes for AIX computer operating systems.

19. The computer usable storage medium of claim 17, wherein said named shared library areas are coactive with said global shared library area in said shared libraries.

20. The computer usable storage medium of claim 17, wherein the computer program when executed further causes:
said automatic creating of new shared library areas by locating an existing named shared library area having the capacity the store the specific process data object.
